(19) United States
(12) Patent Application Publication
(10) Pub. No.: US 2025/0046957 A1
(43) Pub. Date: Feb. 6, 2025

(54) BUSBAR MODULE

(71) Applicant: YAZAKI CORPORATION, Tokyo (JP)

(72) Inventors: Hirotaka Mukasa, Makinohara-shi (JP); Tatsuya Oga, Makinohara-shi (JP); Hirokuni Koike, Makinohara-shi (JP); Yoshiki Aoshima, Makinohara-shi (JP); Kimitoshi Makino, Makinohara-shi (JP)

(21) Appl. No.: 18/815,796

(22) Filed: Aug. 26, 2024

Related U.S. Application Data
(63) Continuation of application No. PCT/JP2023/014146, filed on Apr. 5, 2023.

(30) Foreign Application Priority Data
Apr. 20, 2022 (JP) 2022-069605

(51) Int. Cl. H01M 50/519; H01B 5/14; H01M 50/507

(52) U.S. Cl. CPC H01M 50/519; H01B 5/14; H01M 50/507

(57) ABSTRACT

A busbar module to be attached to a battery assembly in which a plurality of single cells are stacked, the busbar module includes a main line circuit body formed of a flexible substrate having a first wiring pattern and disposed to extend along a stacking direction of the plurality of single cells, a branch line circuit body formed of a flexible substrate having a second wiring pattern and extending so as to branch from the main line circuit body, the second wiring pattern being electrically connected to the first wiring pattern, a busbar connected to an electrode of each of the plurality of single cells, an electronic component attached to a mounting surface of the branch line circuit body so as to connect the second wiring pattern and the busbar, and a holder configured to hold the busbar and be extendable and contractible along the stacking direction.

### CROSS-REFERENCE TO RELATED APPLICATIONS

This is a continuation of International Application No. PCT/JP2023/014146 filed on Apr. 5, 2023, and claims priority from Japanese Patent Application No. 2022-069605 filed on Apr. 20, 2022, the entire content of which is incorporated herein by reference.

### TECHNICAL FIELD

The present disclosure relates to a busbar module.

### BACKGROUND ART

In the related art, a busbar module is used, for example, to be assembled to a battery assembly (a battery module in which a plurality of battery cells are stacked and disposed) as a driving power source mounted on an electric vehicle, a hybrid vehicle, or the like (as disclosed in, for example, JP2014-220128A).

The busbar module described in JP2014-220128A includes a plurality of busbars that are stacked and connect a positive electrode and a negative electrode between adjacent battery cells, and a voltage detection line that is connected to the plurality of busbars and monitors the battery cells. The voltage detection line is configured to bundle a plurality of electric wires having a general structure in which a core wire is covered with an insulating sheath.

In general, the battery cells constituting the battery assembly expand and contract in a stacking direction due to operating heat accompanying charging and discharging, a temperature of an external environment, and the like. As a result, the battery assembly (battery module) is also deformed so as to expand and contract in the stacking direction of the battery cells. Further, the size of the battery assembly in the stacking direction (a front-rear direction) may vary for each of the manufactured battery assemblies due to an assembly tolerance when the plurality of battery cells are stacked and disposed (a manufacturing variation may occur). In general, the busbar module is designed to have a certain margin in the length of the voltage detection line in order to cope with such deformation and a manufacturing variation of the battery assembly.

However, in the above busbar module of the related art, for example, when the number of stacked battery cells is increased for the purpose of increasing the capacity of the battery assembly, the number of electric wires constituting the voltage detection line also increases. As a result, if the voltage detection line is formed by bundling many electric wires, the rigidity of the voltage detection line as a whole (and thus the rigidity of the busbar module) increases, and there is a possibility that it is difficult to improve workability (assemblability) of assembling the busbar module to the battery assembly. For the same reason, there is also a possibility that the busbar module is difficult to extend and contract so as to sufficiently cope with deformation and a manufacturing variation of the battery assembly.

An object of the present invention is to provide a busbar module excellent in assemblability to a battery assembly and followability to deformation and a manufacturing variation of the battery assembly.

### SUMMARY

According to one aspect of the present invention, there is provided a busbar module to be attached to a battery assembly in which a plurality of single cells are stacked, the busbar module including:
a main line circuit body formed of a flexible substrate having a first wiring pattern and disposed to extend along a stacking direction of the plurality of single cells;
a branch line circuit body formed of a flexible substrate having a second wiring pattern and provided separately from the main line circuit body and extending so as to branch from the main line circuit body, the second wiring pattern being electrically connected to the first wiring pattern;
a busbar connected to an electrode of each of the plurality of single cells;
an electronic component attached to a mounting surface of the branch line circuit body so as to connect the second wiring pattern and the busbar; and
a holder configured to hold the busbar and be extendable and contractible along the stacking direction.

### BRIEF DESCRIPTION OF DRAWINGS

FIG. 1 is a perspective view showing a busbar module according to the present embodiment;

FIG. 2 is a perspective view showing a battery assembly to which the busbar module shown in FIG. 1 is assembled;

FIG. 3 is a perspective view showing a state in which a busbar is connected to each of a plurality of branch line circuit bodies connected to a main line circuit body;

FIG. 4 is a perspective view showing one branch line circuit body connected to the main line circuit body;

FIG. 5 is a perspective view showing a state in which the busbar is connected to one branch line circuit body connected to the main line circuit body;

FIG. 6 is a perspective view showing a holder and a cover shown in FIG. 1;

FIG. 7 is a top view showing a connection portion between the branch line circuit body and the busbar; and

FIG. 8 is a perspective view showing a work when the branch line circuit body is connected to the main line circuit body using a jig.

### DESCRIPTION OF EMBODIMENTS

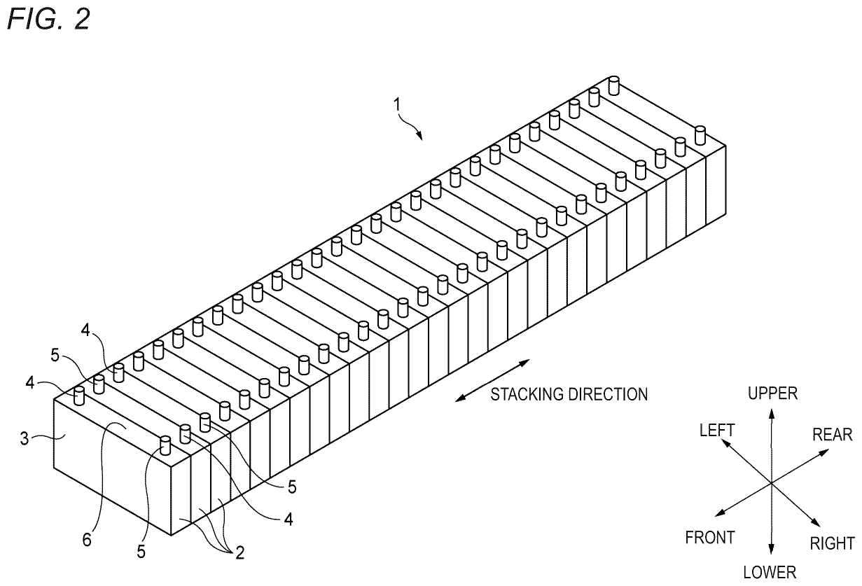

Hereinafter, a busbar module 10 according to an embodiment of the present disclosure will be described with reference to the drawings. The busbar module 10 according to the present embodiment is used, for example, to be assembled to a long battery assembly 1 (see FIG. 2. a battery module in which a plurality of single cells are stacked and disposed) as a driving power source mounted on an electric vehicle.

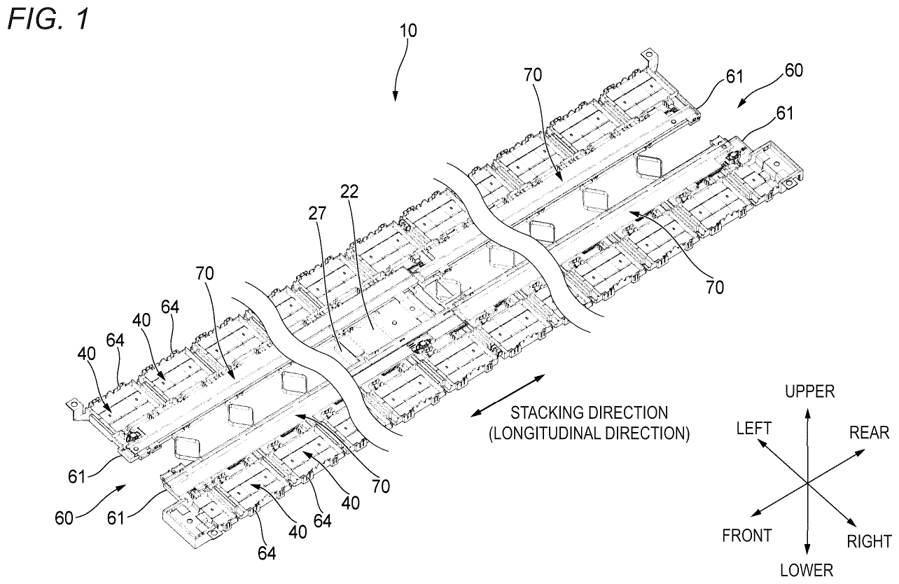

Hereinafter, for convenience of description, “front”, “rear”, “left”, “right”, “upper”, and “lower” are defined as shown in FIG. 1 or the like. A “front-rear direction”, a “left-right direction”, and an “upper-lower direction” are orthogonal to each other. The front-rear direction coincides with a stacking direction (see FIGS. 1 and 2) of a plurality of single cells 2 constituting the battery assembly 1. Note that these directions are defined for convenience of description, and do not necessarily correspond to the front-rear direction, the left-right direction, and the upper-lower direction of the vehicle when the busbar module 10 is mounted on a vehicle.

First, as preparation for describing the busbar module 10, the battery assembly 1 to which the busbar module 10 is attached will be described with reference to FIG. 2. As shown in FIG. 2, the battery assembly 1 is formed by stacking the plurality of rectangular flat plate-shaped single cells 2 extending in the upper-lower direction and the left-right direction in the front-rear direction. Each of the plurality of single cells 2 includes a battery body 3 having a rectangular flat plate shape, and a positive electrode 4 and a negative electrode 5 protruding upward from both left and right end portions of an upper surface 6 of the battery body 3.

In the battery assembly 1, by reversing positions in the left-right direction of the positive electrodes 4 and the negative electrodes 5 of the single cells 2 adjacent to each other in the front-rear direction, the plurality of single cells 2 are stacked such that the positive electrodes 4 and the negative electrodes 5 are alternately arranged in the front-rear direction at a left end portion and a right end portion of an upper surface of the battery assembly 1.

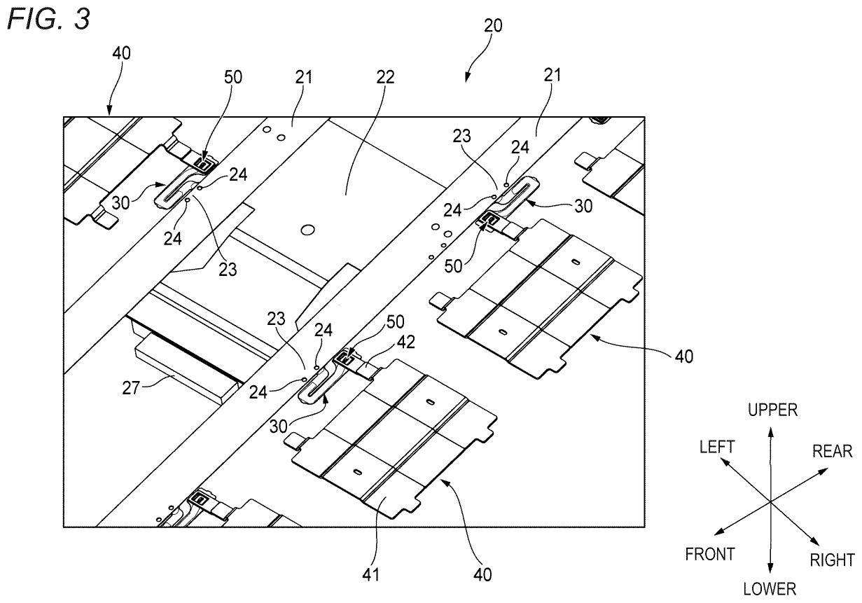

Hereinafter, the busbar module 10 will be described. As shown in FIGS. 1, 3, and 6, the busbar module 10 includes a main line circuit body 20 (see FIG. 3) extending in the front-rear direction, a plurality of branch line circuit bodies 30 connected to the main line circuit body 20, a plurality of busbars 40 respectively connected to the plurality of branch line circuit bodies 30, a plurality of electronic components 50 respectively mounted on the plurality of branch line circuit bodies 30, a holder 60 holding the main line circuit body 20, the branch line circuit bodies 30, and the busbars 40, and a cover 70 covering the main line circuit body 20 and the branch line circuit bodies 30. The main line circuit body 20 is also called a main line, and the branch line circuit body 30 is also called a branch line. Hereinafter, each member constituting the busbar module 10 will be described in order.

First, the main line circuit body 20 will be described. As shown in FIG. 3, the main line circuit body 20 is made of a flexible substrate (FPC) that can be easily bent and integrally includes a pair of left and right strip-shaped body portions 21 extending in the front-rear direction at an interval in the left-right direction, and a connecting portion 22 (see also FIG. 1) connecting the pair of body portions 21 in the left-right direction at a substantially central position in the front-rear direction of the pair of body portions 21. A connector 27 electrically connected to an external voltage detection device (not shown) or the like is mounted on a lower surface of the connecting portion 22.

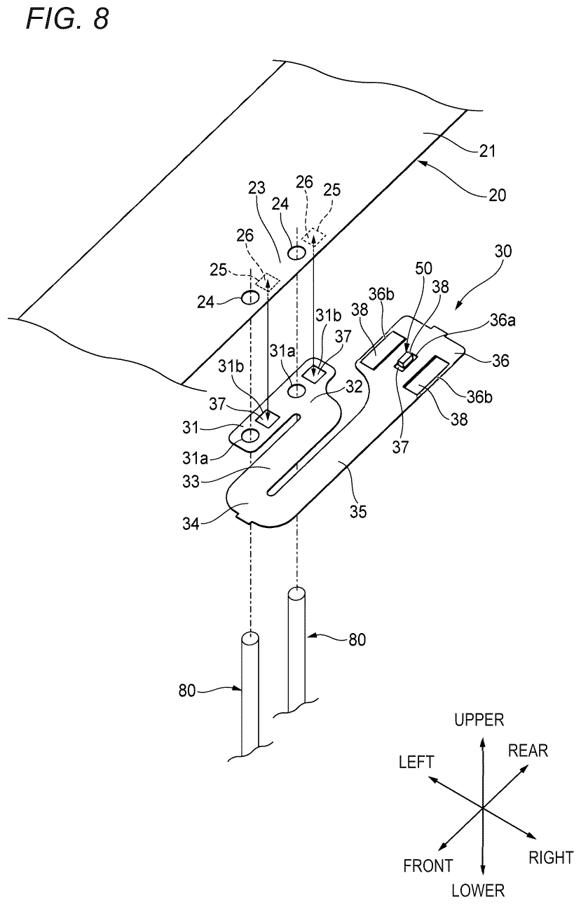

An entire surface of the main line circuit body 20 is formed of a resin layer except opening portions 25 (see FIG. 8) to be described later, and includes wiring patterns 26 (see FIG. 8) to be described later. The wiring pattern 26 is typically a conductor pattern made of copper and extending in a strip shape.

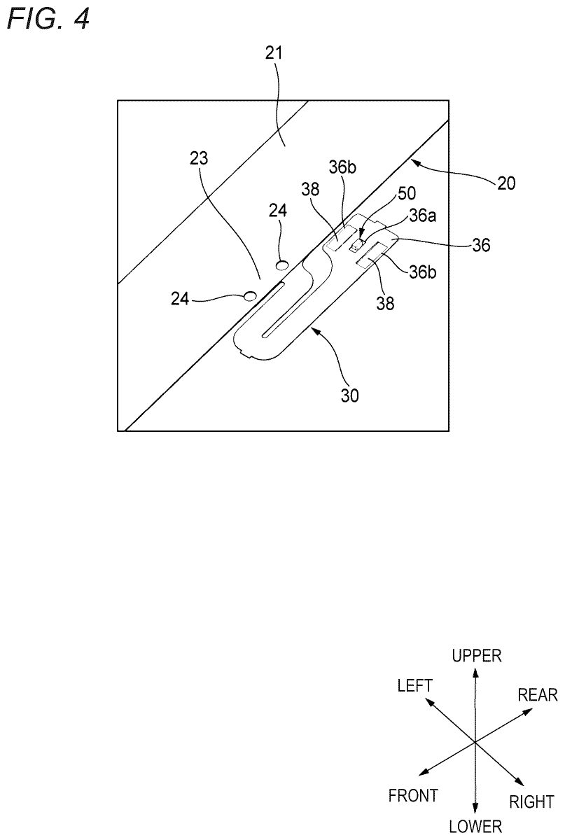

Connecting portions 23 for connecting the branch line circuit bodies 30 are respectively disposed at a plurality of positions in the front-rear direction on outer left-right end portions of the pair of left and right body portions 21 (see FIGS. 3 to 5 and 8). As shown in FIG. 8, each connecting portion 23 is provided with a pair of through holes 24 penetrating in a thickness direction (the upper-lower direction) and arranged at an interval in the front-rear direction. The effect achieved by providing the pair of through holes 24 will be described later.

As shown in FIG. 8, a pair of opening portions 25 from which the resin layer on the surface is removed to expose the wiring patterns 26 are provided on the lower surface of each connecting portion 23 so as to be arranged at an interval in the front-rear direction at positions different from the pair of through holes 24. When the branch line circuit bodies 30 are connected to the main line circuit body 20, the wiring patterns 26 exposed from the pair of opening portions 25 and wiring patterns 37 (see FIG. 8) exposed from a pair of opening portions 31b (to be described later) of the branch line circuit body 30 are electrically connected to each other (soldered in this example). The wiring patterns 26 exposed to the opening portions 25 of each connecting portion 23 are electrically connected to the connector 27 mounted on the connecting portion 22 individually through the inside of the body portion 21 and the connecting portion 22 in this order. Accordingly, the wiring patterns 26 located in each connecting portion 23 are individually electrically connected to the external voltage detection device via the connector 27 mounted on the connecting portion 22.

Next, the branch line circuit body 30 will be described. Similarly to the main line circuit body 20, the branch line circuit body 30 is formed of a flexible substrate (FPC) that can be easily bent. As shown in FIG. 3 and the like, the branch line circuit body 30 is connected to the main line circuit body 20 so as to branch outward in the left-right direction from the connecting portions 23 provided in each of the pair of left and right body portions 21 of the main line circuit body 20.

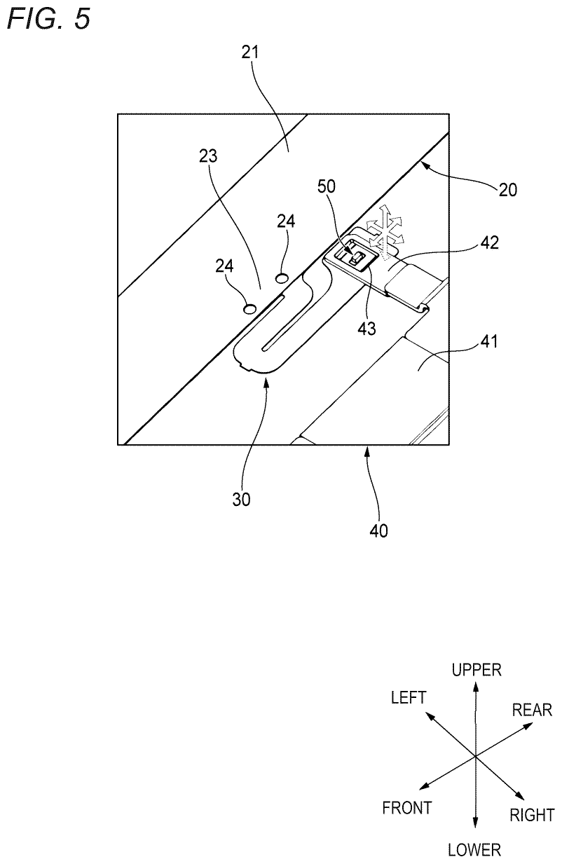

As shown in FIG. 8, the branch line circuit body 30 integrally includes a circuit body-side connecting portion 31 extending in the front-rear direction, a first portion 32 extending outward in the left-right direction from a predetermined position in the front-rear direction of the circuit body-side connecting portion 31, a second portion 33 extending forward in a strip shape from an extending end portion of the first portion 32, a third portion 34 extending outward in the left-right direction from an extending end portion of the second portion 33, a fourth portion 35 extending rearward in a strip shape from an extending end portion of the third portion 34, and a busbar-side connecting portion 36 provided on an extending end portion of the fourth portion 35. Since the branch line circuit body 30 has such a U-shaped curved shape, flexibility of the branch line circuit body 30 in the front-rear direction, the left-right direction, and the upper-lower direction is improved (see white arrows in FIG. 5). The branch line circuit bodies 30 having overall shapes obtained by reversing the overall shapes of the branch line circuit bodies 30 shown in FIG. 8 forward and rearward are connected to some of the plurality of connecting portions 23 of the main line circuit body 20. Hereinafter, for convenience of description, the following description will be given assuming that the branch line circuit body 30 has the overall shape shown in FIG. 8.

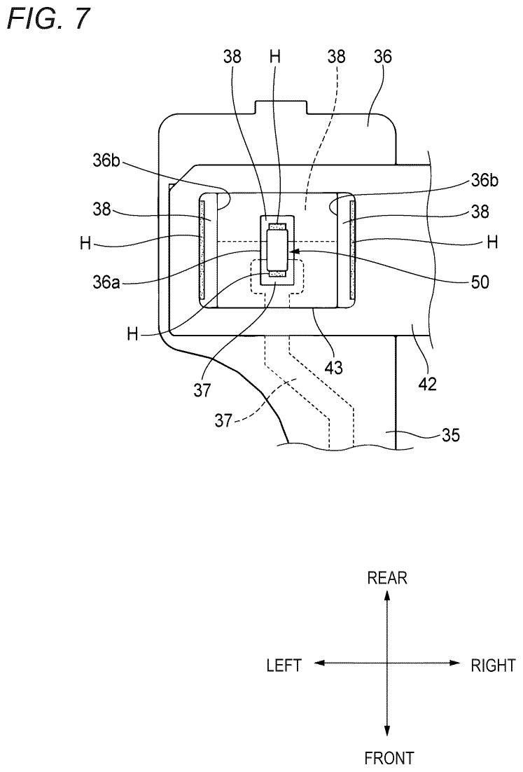

Similarly to the main line circuit body 20, an entire surface of the branch line circuit body 30 is formed of a resin layer except opening portions 31b, 36a, and 36b (see FIG. 8) to be described later, and includes wiring patterns 37, 38 (see FIGS. 7 and 8) to be described later. Each of the wiring patterns 37, 38 is typically a conductor pattern made of copper and extending in a strip shape.

The circuit body-side connecting portion 31 is connected to the connecting portion 23 (the wiring pattern 26) of the main line circuit body 20. In the circuit body-side connecting portion 31, a pair of through holes 31a penetrating in the thickness direction (the upper-lower direction) are provided so as to be arranged at an interval in the front-rear direction, corresponding to the pair of through holes 24 of the connecting portion 23 of the main line circuit body 20 (see FIG. 8). On an upper surface of the circuit body-side connecting portion 31, the pair of opening portions 31b from which the resin layer on the surface is removed to expose the wiring pattern 37 are provided, in correspondence with the pair of opening portions 25 of the connecting portion 23 of the main line circuit body 20, so as to be arranged at an interval in the front-rear direction at positions different from the pair of through holes 31a (see FIG. 8). The wiring patterns 37 exposed to the pair of opening portions 31b extends through the first portion 32, the second portion 33, the third portion 34, the fourth portion 35, and the busbar-side connecting portion 36 in this order to the opening portion 36a provided in the busbar-side connecting portion 36 (see FIGS. 7 and 8).

The busbar-side connecting portion 36 is a portion to which the busbar 40 is connected (see FIG. 5 and the like). As shown in FIGS. 7 and 8, on an upper surface of the busbar-side connecting portion 36, the opening portion 36a from which the resin layer on the surface is removed is provided at a central portion in the left-right direction, and the opening portions 36b from which the resin layer on the surface is removed are formed at a pair of left and right positions sandwiching the opening portion 36a in the left-right direction. An end portion of the wiring pattern 37 is exposed to a front side region of the opening portion 36a, and a part of the wiring pattern 38 separated from the wiring pattern 37 and included in the busbar-side connecting portion 36 is exposed to a rear side region of the opening portion 36a. In each of the pair of opening portions 36b, the other part of the wiring pattern 38 is exposed.

When the busbar 40 is connected to the branch line circuit body 30, the wiring patterns 38 exposed to the pair of opening portions 36b and an extending portion 42 (see FIGS. 3, 5, and 7) to be described later of the busbar 40 are electrically connected (soldered in this example).

The electronic component 50 is mounted on the opening portion 36a of the branch line circuit body 30 (see FIG. 8 and the like). The electronic component 50 is typically a chip fuse. The electronic component 50 is soldered to the wiring pattern 38 and the wiring pattern 37 using the solder H (see FIG. 7) so as to straddle the wiring pattern 38 and the wiring pattern 37 exposed to the opening portion 36a. Accordingly, the wiring patterns 38 (that is, the busbar 40) and the wiring pattern 37 (that is, the wiring pattern 26 of the main line circuit body 20) are electrically connected to each other via the electronic component 50.

The electronic component 50 is mounted on the branch line circuit body 30 in a state before the branch line circuit body 30 is connected to the long main line circuit body 20 long in the front-rear direction (a state of the branch line circuit body 30 alone). Thus, a large-sized mounting device is not required as compared with a case where the main line circuit body 20 and the branch line circuit body 30 are formed of a common flexible substrate. In other words, since the main line circuit body 20 and the branch line circuit body 30 are separate bodies, the electronic component 50 can be properly mounted on the branch line circuit body 30 regardless of the length and size of the main line circuit body 20, and the manufacturing cost of the busbar module 10 can be reduced.

Since the main line circuit body 20 and the branch line circuit body 30 are separate bodies, it is not necessary to process the flexible substrate into a shape in which the branch line circuit body 30 branches from the main line circuit body 20 (for example, to punch out an original plate of the flexible substrate and process the original plate into a shape in which the branch line circuit body 30 branches from the main line circuit body 20), as compared with a case where the main line circuit body 20 and the branch line circuit body 30 are formed of a common flexible substrate. Therefore, the waste amount of scrap pieces generated by such processing can be reduced, and productivity (that is, yield) can be improved. In particular, productivity can be improved in that the original plate portion sandwiched between the branch line circuit bodies 30 adjacent to each other in the stacking direction is not discarded.

A work for connecting the branch line circuit body 30 to the main line circuit body 20 is performed using a rod-shaped positioning jig 80 as shown in FIG. 8. That is, as shown in FIG. 8, first, in a state in which the circuit body-side connecting portion 31 of the branch line circuit body 30 is disposed below the corresponding connecting portion 23 of the main line circuit body 20, the pair of rod-shaped jigs 80 are inserted into the pair of through holes 31a of the branch line circuit body 30 and the pair of through holes 24 of the main line circuit body 20 in this order from below. Thus, a state is obtained in which the pair of through holes 31a of the branch line circuit body 30 and the pair of through holes 24 of the main line circuit body 20 are aligned so as to overlap each other in the upper-lower direction.

Next, the wiring patterns 26 exposed from the pair of opening portions 25 of the main line circuit body 20 and the wiring patterns 37 exposed from the pair of opening portions 31b of the branch line circuit body 30 are soldered. Typically, the soldering may be performed by a method (a so-called pulse heat soldering) in which, after a paste-shaped solder is sandwiched between the wiring pattern 26 and the wiring pattern 37, a heater chip capable of heating the solder to a temperature at which the solder can be melted is pressed against a soldering portion and the heater chip is heated to perform the soldering. The soldering may be performed by a reflow soldering process using a heating furnace. Further, the electrical connection between the wiring pattern 26 of the main line circuit body 20 and the wiring pattern 37 of the branch line circuit body 30 may be performed using a conductive adhesive instead of the above soldering.

Thus, the branch line circuit body 30 is connected to the main line circuit body 20 in a state in which the wiring pattern 26 of the main line circuit body 20 and the wiring pattern 37 of the branch line circuit body 30 are electrically connected to each other. As described above, since the through hole 31a of the branch line circuit body 30 and the through hole 24 of the main line circuit body 20, and the rod-shaped jig 80 are used, it is possible to prevent a positional deviation or the like that occurs when the wiring pattern 26 and the wiring pattern 37 are soldered together. Accordingly, reliability of the electrical connection between the main line circuit body 20 and the branch line circuit body 30 can be improved.

Next, the busbar 40 will be described. The busbar 40 is formed by one metal plate being subjected to pressing processing (punching processing), bending processing, or the like. As shown in FIG. 3, the busbar 40 includes a busbar body 41 having a substantially rectangular flat plate shape, and an extending portion 42 extending inward in the left-right direction from a rear end portion of an inner edge portion in the left-right direction extending in the front-rear direction of the busbar body 41. A through hole 43 (see FIGS. 5 and 7) that opens in a thickness direction (vertical direction) is formed at an extending end portion of the extending portion 42. The through hole 43 functions as an escape portion for avoiding interference between the extending end portion of the extending portion 42 of the busbar 40 and the electronic component 50 when the busbar 40 is connected to the branch line circuit body 30.

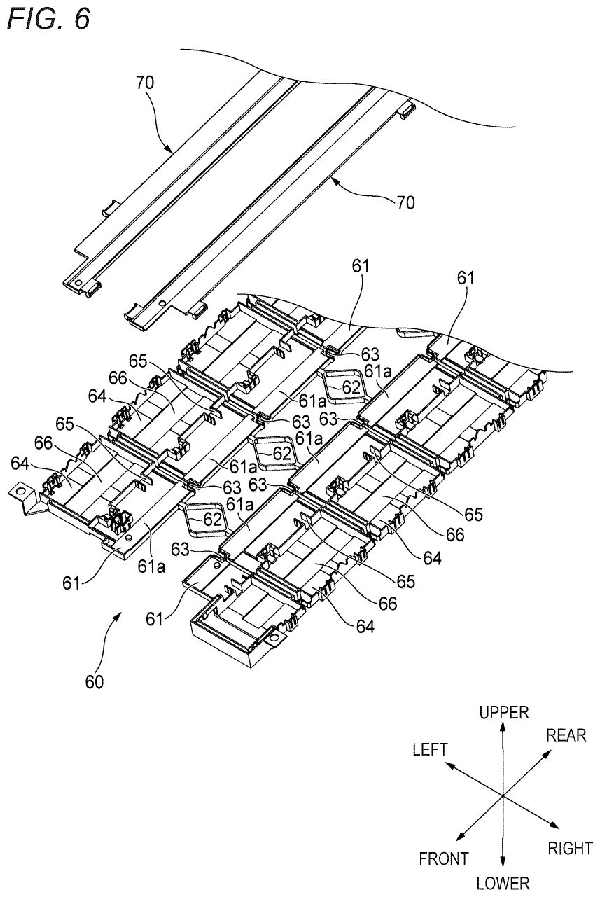

Next, the holder 60 will be described. The holder 60 is a resin molded product, and as shown in FIG. 6, integrally includes a pair of left and right strip-shaped circuit body holding portions 61 that are disposed at an interval in the left-right direction and each extend in the front-rear direction, and a plurality of connecting portions 62 that connect the pair of left and right circuit body holding portions 61 in the left-right direction at a plurality of positions in the front-rear direction. The pair of left and right body portions 21 of the main line circuit body 20 and the plurality of branch line circuit bodies 30 branching from the body portions 21 are placed on the pair of left and right circuit body holding portions 61.

Specifically, each of the pair of circuit body holding portions 61 extending in the front-rear direction includes a plurality of divided bodies 61a arranged side by side in the front-rear direction, and extension and contraction portions 63 each connecting the divided bodies 61a adjacent to each other in the front-rear direction to each other in the front-rear direction. Each of the extension and contraction portions 63 has a shape that is easily extended and contracted in the front-rear direction due to elastic deformation. Therefore, the pair of circuit body holding portions 61 are extendable and contractible along the front-rear direction.

With respect to each of the pair of left and right circuit body holding portions 61, each of the plurality of divided bodies 61a arranged in the front-rear direction is integrally provided with a busbar holding portion 64 so as to be adjacent to an outer side in the left-right direction. That is, the plurality of busbar holding portions 64 are arranged side by side in the front-rear direction on the outer side in the left-right direction of each of the pair of left and right circuit body holding portions 61. Since each of the busbar holding portions 64 is provided in the corresponding divided body 61a, an interval in the front-rear direction between the busbar holding portions 64 adjacent to each other in the front-rear direction can be changed by a function of the extension and contraction portion 63.

The busbar body 41 of the busbar 40 is accommodated in the busbar holding portion 64. Therefore, the busbar holding portion 64 has a substantially rectangular box shape opening upward corresponding to an outer shape of the busbar body 41. A notch 65 is formed in a portion of a rectangular frame-shaped side wall portion of the busbar holding portion 64 where the extending portion 42 of the busbar 40 crosses, in order to avoid interference with the extending portion 42. An opening 66 extending in the front-rear direction is formed in a bottom wall portion of the busbar holding portion 64. When the holder 60 is attached to the battery assembly 1, the positive electrodes 4 and the negative electrodes 5 that are adjacent to each other in the front-rear direction are disposed in the openings 66 of the busbar holding portions 64.

Next, the cover 70 will be described. The cover 70, which is a resin molded product, has a function of covering the pair of left and right body portions 21 of the main line circuit body 20, which are long in the front-rear direction, and the plurality of branch line circuit bodies 30 branching from the body portions 21, which are placed on the pair of left and right circuit body holding portions 61 that are long in the front-rear direction of the holder 60 (see FIG. 1). Therefore, as shown in FIG. 6, the cover 70 has a strip shape formed to be long in the front-rear direction. The members constituting the busbar module 10 have been described above.

In an attachment completion state in which the busbar module 10 is attached to the battery assembly 1, in the battery assembly 1, the plurality of stacked single cells 2 are electrically connected in series via the plurality of busbars 40. Further, each busbar 40 is electrically connected to the external voltage detection device via the wiring pattern 38 of the corresponding branch line circuit body 30, the electronic component 50, the wiring pattern 37 of the corresponding branch line circuit body 30, the wiring pattern 26 positioned at the corresponding connecting portion 23 of the main line circuit body 20, and the connector 27 mounted on the connecting portion 22 of the main line circuit body 20 in this order. Accordingly, a voltage (potential) of each busbar 40 can be individually detected by the external voltage detection device. When an excessive current equal to or greater than a rated current flows in the electronic component 50 for some reason, an electrical connection between the wiring patterns 37, 38 is cut off by the electronic component 50 due to an effect of a fuse function of the electronic component 50. Accordingly, the excessive current is prevented from flowing into the voltage detection device, so that the voltage detection device can be protected.

In the use state of the battery assembly 1 to which the busbar module 10 is attached, each of the single cells 2 constituting the battery assembly 1 may expand or contract in the stacking direction (the front-rear direction) due to operation heat associated with charging and discharging, a temperature of an external environment, and the like. As a result, the battery assembly 1 may deform to expand and contract in the stacking direction (front-rear direction). Further, the size of the battery assembly 1 in the stacking direction (the front-rear direction) may vary for each of the manufactured battery assemblies 1 due to an assembly tolerance when the plurality of single cells 2 are stacked and disposed (a manufacturing variation may occur).

In this regard, in the busbar module 10, even if the extension and contraction of the battery assembly 1 in the stacking direction (the front-rear direction) due to the thermal deformation of each single cell 2 and the manufacturing variation of the battery assembly 1 occur, since each of the plurality of extension and contraction portions 63 of the holder 60 extends and contracts in the front-rear direction, and the branch line circuit body 30 is easily bent, the extension and contraction due to the thermal deformation of the battery assembly 1 and a manufacturing variation can be easily absorbed.

As described above, according to the busbar module 10 of the present embodiment, the branch line circuit bodies 30 formed of the flexible substrate are electrically connected to the main line circuit body 20 formed of the flexible substrate, and the branch line circuit bodies 30 extend so as to branch from the main line circuit body 20. Further, when the battery assembly 1 extends and contracts in the stacking direction due to the thermal deformation of each single cell 2, each busbar 40 can move in the stacking direction of the single cells 2 by bending or the like of the branch line circuit body 30. Similarly, when the branch line circuit body 30 is bent or the like, a variation in the size of the battery assembly 1 in the stacking direction due to the assembly tolerance of the single cells 2 can be absorbed. In other words, the busbar module 10 according to the present embodiment can easily cope with the extension and contraction and a manufacturing variation of the battery assembly 1 due to the deformation of the branch line circuit body 30. Here, in general, even when the flexible substrate includes a large number of circuit structures, the flexible substrate is easily deformed flexibly with much smaller force than the electric wire used in the above busbar module of the related art. Therefore, assemblability to the battery assembly 1 is improved. Accordingly, the busbar module 10 according to the present embodiment is more excellent in assemblability to the battery assembly 1 and followability to deformation and a manufacturing variation of the battery assembly 1 than the above busbar module of the related art.

For another effect, since the main line circuit body 20 and the branch line circuit body 30 are separate bodies, it is not necessary to process the flexible substrate into a shape in which the branch line circuit body 30 branches from the main line circuit body 20 (for example, the above punching process), as compared with a case where the main line circuit body 20 and the branch line circuit body 30 are formed of a common flexible substrate. Therefore, the waste amount of scrap pieces generated by such processing can be reduced, and productivity (that is, yield) can be improved. In addition, since the electronic component 50 is attached (that is, mounted) to the branch line circuit body 30 that is separate from the main line circuit body 20, a large-sized mounting device is not required as compared with the case where the main line circuit body 20 and the branch line circuit body 30 are formed of a common flexible substrate. In other words, the electronic component 50 can be appropriately mounted on the branch line circuit body 30 regardless of the length and size of the main line circuit body 20.

The branch line circuit body 30 has a curved shape including a pair of strip-shaped portions (the second portion 33 and the fourth portion 35) extending along the stacking direction (the front-rear direction) and a connecting portion (the third portion 34) connecting one end of one strip-shaped portion and one end of the other strip-shaped portion. Since the flexibility of the branch line circuit body 30 is improved by such a curved shape, it is possible to further improve the assemblability to the battery assembly 1 and the followability to deformation and a manufacturing variation of the battery assembly 1.

Since a first hole portion (the through hole 24) of the main line circuit body 20 and a second hole portion (the through hole 31a) of the branch line circuit body 30 are aligned so as to overlap each other (for example, the rod-shaped jig 80 is inserted into the first hole portion 24 and the second hole portion 31a), it is possible to prevent a positional deviation or the like that occurs when the first wiring pattern (the wiring pattern 26) and the second wiring pattern (the wiring pattern 37) are soldered together. Accordingly, reliability of the electrical connection between the main line circuit body 20 and the branch line circuit body 30 can be improved.

The present invention is not limited to the embodiment described above, and various modifications can be adopted within the scope of the present invention. For example, the invention is not limited to the embodiment described above, and modifications, improvements, and the like can be made appropriately. In addition, materials, shapes, sizes, numbers, arrangement positions, or the like of components in the embodiment described above are freely selected and are not limited as long as the present invention can be implemented.

In the embodiment described above, the branch line circuit body 30 has a curved shape including the pair of strip-shaped portions (the second portion 33 and the fourth portion 35) extending along the stacking direction (the front-rear direction) and the connecting portion (the third portion 34) connecting the one end of the one strip-shaped portion and the one end of the other strip-shaped portion. In contrast, the branch line circuit body 30 may not have such a curved shape.

Further, in the embodiment described above, the main line circuit body 20 has the first hole portion (through hole 24), and the branch line circuit body 30 has the second hole portion (through hole 31a). In contrast, the main line circuit body 20 and the branch line circuit body 30 may not have the first hole portion and the second hole portion, respectively.

Here, in the embodiment according to the present invention described above, there is provided a busbar module (10) to be attached to a battery assembly (1) in which a plurality of single cells (2) are stacked, the busbar module (10) including:
a main line circuit body (20) formed of a flexible substrate having a first wiring pattern (26) and disposed to extend along a stacking direction of the plurality of single cells (2);
a branch line circuit body (30) formed of a flexible substrate having a second wiring pattern (37, 38) and provided separately from the main line circuit body (20) and extending so as to branch from the main line circuit body (20), the second wiring pattern (37) being electrically connected to the first wiring pattern (26);
a busbar (40) connected to an electrode (4, 5) of each of the plurality of single cells (2);
an electronic component (50) attached to a mounting surface of the branch line circuit body (30) so as to connect the second wiring pattern (38) and the busbar (40); and
a holder (60) configured to hold the busbar (40) and be extendable and contractible along the stacking direction.

According to the busbar module having the above configuration, the branch line circuit body (hereinafter, also referred to as a branch line) formed of the flexible substrate is electrically connected to the main line circuit body (hereinafter, also referred to as a main line) formed of the flexible substrate, and the branch line circuit body extends so as to branch from the main line circuit body. Further, when the battery assembly extends and contracts in the stacking direction due to thermal deformation of each single cell, each busbar can move in the stacking direction of the single cells by bending or the like of the branch line circuit body. Similarly, when the branch line circuit body is bent or the like, a variation in the size of the battery assembly in the stacking direction due to an assembly tolerance of the single cells can be absorbed. In other words, the busbar module according to the present configuration can easily cope with the extension and contraction and a manufacturing variation of the battery assembly due to deformation of the branch line circuit body. Here, in general, even when the flexible substrate includes a large number of circuit structures, the flexible substrate is easily deformed flexibly with much smaller force than the electric wire used in the above busbar module of the related art. Therefore, assemblability to the battery assembly is improved. Accordingly, the busbar module according to the present configuration is more excellent in assemblability to the battery assembly and followability to deformation and a manufacturing variation of the battery assembly than the above busbar module of the related art.

According to the busbar module having the above configuration, the main line circuit body and the branch line circuit body are prepared as separate bodies and then electrically connected to each other. Therefore, as compared with the case where the main line circuit body and the branch line circuit body are constituted by a single continuous flexible substrate, it is not necessary to process the flexible substrate into a shape in which the branch line circuit body branches from the main line circuit body (for example, to punch out an original plate of the flexible substrate and process the original plate into a shape in which the branch line circuit body branches from the main line circuit body). Therefore, the waste amount of scrap pieces generated by such processing can be reduced, and productivity (that is, yield) can be improved. In particular, productivity can be improved in that the original plate portion sandwiched between the branch line circuit bodies adjacent to each other in the stacking direction is not discarded. In addition, since the electronic component is attached (that is, mounted) to the branch line circuit body prepared separately from the main line circuit body, a large-sized mounting device for mounting the electronic component is not required as compared with a case where the main line circuit body and the branch line circuit body are formed of an integrated flexible substrate. In other words, regardless of the length and size of the main line circuit body, the electronic component can be properly mounted on the branch line circuit body by using a general mounting device, and the manufacturing cost of the busbar module can be reduced.

Further, the branch line circuit body (30) may have a curved shape in at least a part of the branch line circuit body (30), the curved shape having a pair of strip-shaped portions (33, 35) extending along the stacking direction, and a connecting portion (34) connecting one end of one strip-shaped portion (33) and one end of another strip-shaped portion (35).

According to the busbar module having the above configuration, the branch line circuit body has a curved shape (for example, a U-shaped curved shape) including the pair of strip-shaped portions extending along the stacking direction and the connecting portion connecting the one end of the one strip-shaped portion and the one end of the other strip-shaped portion. Since the flexibility of the branch line circuit body is further improved by such a curved shape, it is possible to further improve the assemblability to the battery assembly and the followability to deformation and a manufacturing variation of the battery assembly.

Further, the main line circuit body (20) may have a first hole portion (24) penetrating the main line circuit body (20) in a thickness direction,
the branch line circuit body (30) may have a second hole portion (31a) penetrating the branch line circuit body (30) in the thickness direction, and
the first wiring pattern (26) and the second wiring pattern (37) are configured to be electrically connected in a state in which the first hole portion (24) and the second hole portion (31a) are aligned so as to overlap each other.

According to the busbar module having the above configuration, since the first hole portion of the main line circuit body and the second hole portion of the branch line circuit body are aligned so as to overlap each other (for example, a rod-shaped jig is inserted into the first hole portion and the second hole portion), it is possible to prevent a positional deviation or the like between both wiring patterns that occurs when the first wiring pattern and the second wiring pattern are electrically connected (for example, soldered). Accordingly, the reliability of the electrical connection between the main line circuit body and the branch line circuit body can be improved.

The busbar module according to the present invention is excellent in assemblability to the battery assembly and followability to deformation and a manufacturing variation of the battery assembly. The present invention having this effect can be used, for example, to be assembled to a long battery assembly (for example, a battery module in which a plurality of single cells are stacked and disposed) as a driving power source mounted on an electric vehicle.

What is claimed is:

1. A busbar module to be attached to a battery assembly in which a plurality of single cells are stacked, the busbar module comprising:
a main line circuit body formed of a flexible substrate having a first wiring pattern and disposed to extend along a stacking direction of the plurality of single cells;
a branch line circuit body formed of a flexible substrate having a second wiring pattern and provided separately from the main line circuit body and extending so as to branch from the main line circuit body, the second wiring pattern being electrically connected to the first wiring pattern;
a busbar connected to an electrode of each of the plurality of single cells;
an electronic component attached to a mounting surface of the branch line circuit body so as to connect the second wiring pattern and the busbar; and
a holder configured to hold the busbar and be extendable and contractible along the stacking direction.

2. The busbar module according to claim 1, wherein
the branch line circuit body has a curved shape in at least a part of the branch line circuit body, the curved shape having a pair of strip-shaped portions extending along the stacking direction, and a connecting portion connecting one end of one strip-shaped portion and one end of another strip-shaped portion.

3. The busbar module according to claim 1, wherein
the main line circuit body has a first hole portion penetrating the main line circuit body in a thickness direction,
the branch line circuit body has a second hole portion penetrating the branch line circuit body in the thickness direction, and
the first wiring pattern and the second wiring pattern are configured to be electrically connected in a state in which the first hole portion and the second hole portion are aligned so as to overlap each other.
